(19) United States
(12) Patent Application Publication
(10) Pub. No.: US 2025/0260880 A1
(43) Pub. Date: Aug. 14, 2025

(54) Method and System for Generating Real Time Updates

(71) Applicant: Glance InMobi Pte. Ltd.

(72) Inventors: Manish Kumar Gupta, Bengaluru (IN); Chandrashekhar Iyer, Bangalore (IN); Manan Saxena, Bengaluru (IN); K.V. Nanjaraje Urs, Bengaluru (IN); Karthik Sai Malala, Bangalore (IN); Anmol Loonia, Bangalore (IN); Baidyanath Prasad, Bengaluru (IN); Ritesh Jha, Bangalore (IN)

(73) Assignee: Glance InMobi Pte. Ltd., (omitted)

(21) Appl. No.: 19/046,498

(22) Filed: Feb. 5, 2025

(30) Foreign Application Priority Data
Feb. 8, 2024 (IN) 202411008601

(51) Int. Cl. H04N 21/81; H04N 21/2187; H04N 21/234

(52) U.S. Cl. CPC H04N 21/8133; H04N 21/2187; H04N 21/23418

(57) ABSTRACT

A method and a system for automatically generating one or more real time updates for at least one live event is described. In one example, a processing unit is connected to a storage unit and a display unit, said processing unit fetches a content stream of the at least one live event and identifies at least one moment from the content stream. Based on the identified moment, at least one real time update is generated by the processing unit. The generated real time updated is then displayed on the display unit.

### TECHNICAL FIELD

The present disclosure generally relates to methods and systems of information technology and content delivery. More particularly, the present disclosure relates to a method and a system for generating real time updates for live events.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as an admission of prior art.

With advancement in technologies and emphasis on real-time content delivery to users, there has been an increase in the telecast of important event(s) worldwide over content platform(s). Both consumers and businesses worldwide have turned to content delivery platforms, making events more accessible across various devices. The events may include but are not limited to time bound events such as sports game, election, budgets, natural disaster, and other live events. The content delivery platforms today offer both-live as well as static events.

But with increasing time constraints of the viewer(s), the viewer tends to look for momentary follow-ups of live events rather than following the whole duration of event. Live events generally span for a definite duration of time. For e.g., sports games/matches are currently viewed through live streams on TVs or content delivery platforms. However, if a viewer is not watching the live event from the start of the event, he/she is bound to miss out on knowing the important highs and lows of the event and happenings took place that proved significant for the live event. Thus, during the time when the viewer is not following up the live event, the viewer had to miss some or whole part of the live event as it is not possible for them to know what significant happened in the event during that short period. They must watch the entire elapsed time of the live event which might not always be available.

The existing solutions for event media visualization are riddled with various shortcomings. One major drawback is that the viewer must watch highlights of the event on linear TV channels or other content delivery platforms like Over-The-Air (OTT) applications. This is as per the likings of the broadcasting corporations which think only a particular section of the event-media is relevant and significant for showcasing to the user. There are other video sharing platforms that publish the highlights, but they are published after the live event is over or is not published in real-time. The important events are often published with a delay (mostly after the live event has ended) which requires manual effort of publishing. The publishing efforts often bear high production costs by the editors along the assembly line. This cost increases significantly when multiple variations are required to evaluate the event information for generating moments along with their timelines. Additionally, sourcing copyright-free moments from different platforms also poses a potential challenge which only adds to the complexity and expense of the process.

Currently, there are no existing solutions that provide a real-time update on the live event/ongoing events. Also, there is a need to enable the viewer to catch up with key past happenings of an event (whether live or past) in a chronological manner as desired by the viewer for which there are no existing solution.

Therefore, there are several limitations to the existing solutions and in order to overcome these and such other limitations of the known solutions it is necessary to provide an efficient solution for automatic event-media visualization.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a method for automatically generating one or more real-time updates for at least one live event. The method comprises fetching, by a processing unit, a content stream associated with the at least one live event. Further, the method comprises identifying, by the processing unit, at least one moment from the content stream. Hereinafter, the method comprises generating, by the processing unit, at least one real time update for the at least one moment. Further, the method comprises displaying, by the processing unit, the at least one real time update on a display unit.

In an exemplary aspect of the present disclosure, the content stream is fetched from one or more external utilities comprising at least one of a live streaming event and a news event.

In an exemplary aspect of the present disclosure, the identifying of the at least one moment from the content stream further comprises categorizing one or more input data of the content stream into one of at least one relevant event and at least one irrelevant event by the processing unit. Further, the identifying of the least one moment from the content stream comprises calculating an importance score of the at least one relevant event. Further, the method includes identifying the at least one moment from the at least relevant event based on the importance score.

In an exemplary aspect of the present disclosure, generating the at least one real time update further comprises determining one or more tags for the at least one moment. The method further comprises generating, by the processing unit, a text summary for the at least one moment. Further, the method comprises identifying, by the processing unit, an image for the at least one relevant moment based on the text summary and the one or more tags. Furthermore, the method comprises combining, by the processing unit, the text summary and the identified image to generate the at least one real-time update.

In an exemplary aspect of the present disclosure, the method further comprises determining, by the processing unit, a progress of the content stream for the at least one live event. Further, the method comprises dynamically merging, by the processing unit, the at least one real time update into a timeline based on the progress. Hereinafter, the method comprises displaying, by the processing unit, the timeline on the display unit.

Another aspect of the present disclosure may relate to a system for automatically generating one or more real time updates for at least one live event. The system comprises a processing unit connected to a storage unit and a display unit. The processing unit is configured to fetch a content stream associated with the at least one live event. Further, the processing unit is configured to identify at least one moment from the content stream. The processing unit is further configured to generate at least one real time update for the at least one moment. The display unit is configured to display the at least one real time update.

Yet another aspect of the present disclosure may relate to a non-transitory computer readable storage medium storing instructions for automatically generating one or more real time updates for at least one live event, the instructions include executable code which, when executed by one or more units of a system, cause a processing unit of the system to fetch a content stream associated with the at least one live event. The instructions when executed by the system further cause the processing unit of the system to identify at least one moment from the content stream. The instructions when executed by the system further cause the processing unit of the system to generate at least one real time update for the at least one moment. The instructions when executed by the system further cause a display unit to display the at least one real time update.

### Exemplary Objects of the Disclosure

This section is provided to introduce certain objects and aspects of the present systems and methods described herein in a simplified form that are further described below in the description. In order to overcome at least a few problems associated with the known solutions as provided in the previous section, an exemplary object of the systems and methods described herein is to substantially reduce the limitations and drawbacks of the prior arts as described hereinabove. Following are additional objects.

An object of the systems and methods described herein is to keep viewer updated with key happenings of live events in real time.

Another object of the systems and methods described herein is to update the viewer of live events in real-time through related visuals and text of the key happening.

Yet another object of the systems and methods described herein is to help viewer catch up with key past happenings of an event (live or past) through a collection of updates arranged in a chronological manner.

Yet another object of the present systems and methods described herein is to update the viewer in real time (within a predefined short time instance) with major happenings in live/ongoing events through Moments that consist of a visual and short title representing the happening.

Yet another object of the systems and methods described herein is to generate real-time updates and add to the chronology as the event progresses.

### BRIEF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art that other connections may also be possible, without departing from the scope of the systems and methods described herein. All sub-components within a component may be connected to each other, unless otherwise indicated.

FIG. 1 illustrates an exemplary system [100] for automatically generating real time updates for live events.

FIG. 2 illustrates an exemplary method [200] for automatically generating real time updates for live events.

FIG. 3 illustrates an exemplary method [300] for automatic generation of real time updates for real time event.

FIG. 4 illustrates an exemplary method [400] for backend publishing real-time updates for real time event.

FIG. 5 illustrates an exemplary implementation [500] of a generated moment of a real-time event.

### DETAILED DESCRIPTION

In the following description, for the purposes of explanation, various specific details are set forth in order to provide a thorough understanding of the embodiments of the present systems and methods described herein. It will be apparent, however, that embodiments of the present systems and methods described herein may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present systems and methods described herein are described below, as illustrated in various drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “exemplary” and/or “demonstrative” as used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a (Digital Signal Processing) DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a computing device”, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from at least one of a transceiver unit, a processing unit, a storage unit, a detection unit and any other such unit(s) which are required to implement the features of the present disclosure.

As used herein, a “storage unit” or a “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein “interface” or “user interface” refers to a shared boundary across which two or more separate components of a system exchange information or data. The interface may also be referred to a set of rules or protocols that define communication or interaction of one or more modules or one or more units with each other, which also includes the methods, functions, or procedures that may be called.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

As discussed in the background section, the current known solutions have several shortcomings. The current known solutions do not provide real-time updates for live events. The updates are generally generated after expiry of the real-time event. Furthermore, the generation of updates involves manual efforts and high costs. The present systems and methods described herein relate to novel methods and systems for event-media visualization. More particularly, the methods and systems of the present systems and methods described herein relate to automatic generation of real-time updates for a real-time event. Specifically, the present systems and methods described herein pertain to systems and methods that generates updates in real time (within a pre-defined short time instance) by taking the event information (through APIs/feeds), deciding whether it qualifies as a relevant update and generating a short text description and a visual image related to the update. As time of the event elapses, the systems and methods described herein select some or all of the generated updates based on their importance/relevance in real time and arrange them automatically in a chronological order in a timeline manner to indicate the order in which the events occurred, which the viewers can view/navigate for a glanceable visual summary of the event or a part of it which has elapsed.

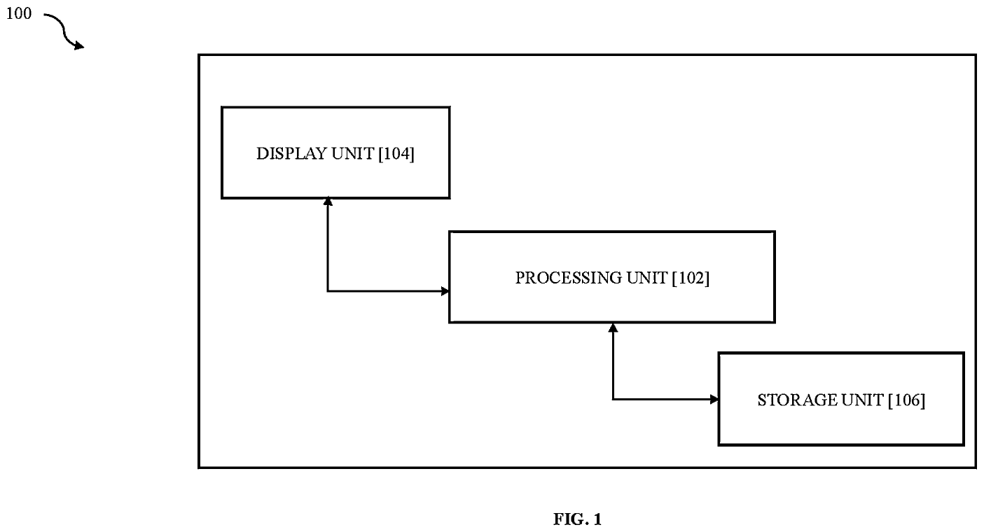

Referring to FIG. 1, a system [100] for automatically generating one or more real time updates for at least one live event is shown. The system [100] comprises at least one processing unit [102], at least one display unit [104] and at least one storage unit [106]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure.

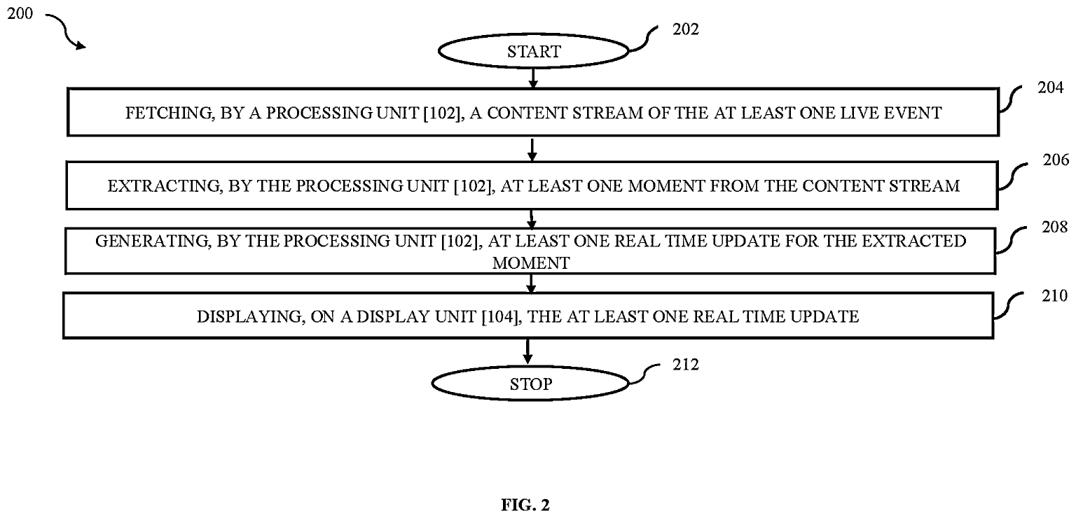

Furthermore, in an implementation, the system [100] may be present in a user/viewer device to implement the features of the present systems and methods described herein. The system [100] may be a part of the user device/or may be independent of but in communication with the user device. In another implementation, the system [100] may reside in a server. In yet another implementation, the system [100] may reside partly in the server and partly in the user device. In an implementation, a method [200] as shown in FIG. 2 is performed by the system [100] as depicted in FIG. 1.

The processing unit [102] is configured to fetch a content stream associated the at least one live event. In an implementation of the present disclosure, the content stream is fetched from one or more external utilities or applications streaming or broadcasting the live events. The content stream refers to real-time continuous information pertaining to a live event. The one or more external utilities may be one of a live streaming utility, a news event, and the like. In an implementation of the present systems and methods described herein, beginning of the at least one live event or a live event already in progress may be detected by the processing unit [102] to start fetching the content stream. In one example, the content stream of the live event is received through application programming interfaces (APIs)/Feeds/Streams present on the system [100] provided by the one or more external utilities. In an exemplary embodiment of the systems and methods described herein, where the live event relates to a cricket game, the one or more external utilities may include an API that may include the detailed live score or a commentary feed.

Further, the processing unit [102] is configured to identify at least one moment from the content stream. To identify the at least one moment, the processing unit [102] is configured to analyze the content stream of the at least one live event. In an implementation of the present solution, a natural language processing model may be used to analyse the content stream. The natural language processing model may convert natural language in the content stream to a machine readable language. In one example, the analysis can be done right from start of the live event to completion of the live event in real-time using intelligence models, where the intelligence models analyse based on highlights of previous similar events that have been noteworthy. The previous similar event highlights may be stored into an artificial intelligence (AI) model as training data, based on which the system [100] identifies the relevant event in the live event.

To identify the at least one moment, the processing unit [102] may be configured to categorize the one or more input data coming in the content stream into one of at least one relevant event and at least one irrelevant event. The at least one relevant event refers to an important milestone in the content stream. For instance, in the case of the live cricket event, the at least one relevant event of the analysed content stream may include a player completing 50/100 runs, a wicket, a catch out, missed wickets, reviews, winning, losing, and the like. The irrelevant event refers to parts of the content stream not contributing to the generation of real-time updates. For instance, in a natural disaster live information, the at least one irrelevant event of the content stream may include advertisements, an interview of a nature specialist, and the like.

After categorizing the content stream into the at least one relevant event and the at least one irrelevant stream, at least one moment may be identified from the at least one relevant event. The method further encompasses calculating an importance score of the at least one relevant event. The importance score refers to criticality or importance of the event. In an implementation of the present solution, a natural language processing AI model processes the information of the event and qualifies it as a moment based on the criticality/importance of the happening. Therefore, in an implementation of the present disclosure, the at least one moment may be identified based on the importance score. In one example, based on the number of words spoken in a predetermined time duration, a high pitch of a speaker in the content, the processing unit [102] may qualify the content stream as the relevant event. It is to be noted that as used herein a ‘moment’ refers to a portion of a pre-defined time interval of the live event. For instance, in the said case of live cricket game the moment may include a clip of 10 seconds wherein a sixer is struck by the batsman.

In a further exemplary implementation, the intelligence model may have stored one or more moments from a previous of a live cricket match event. In one example, the one or more moments include but are not limited to 4 s and 6 s scored; personal milestone of a player; a hat trick; missed catch of a key batsman or a century. The intelligence model may use the one or more moments in the previous live cricket match event to identify the one or more moments in the live event. Another instance may include an event like a nation's budget presentation which may have a moment like key regulation change that impacts certain industry.

The processing unit [102] is further configured to generate at least one real time update for the at least one moment. The at least one real time update includes but may not be limited to determining one or more tags, generating a text summary and an image. In an implementation of the systems and methods described herein, the natural language processing AI model processes the identified moment and generates one or more tags relevant to the at least one moment. As used herein, the ‘one or more tags’ refers to an attribute associated with the at least one moment. For example, in the said case of the live cricket game event, the one or more tags may include a name of a player, an event name, a score, a team name, an opposition team name, a tournament name, and the like. Further, based on the one or more tags, the text summary may be generated. The text summary, as used herein, refers to a short text description of the at least one moment.

Further, the processing unit [102] identifies an image for the at least one relevant event based on the generated text summary and the one or more tags. In one example, the image may be selected from a storage unit [106]. In another example, the image may be generated using an intelligence model. The images may be pre-stored by a system operator in the storage unit [106] or may be stored from previously generated images. In an implementation of the present disclosure, the image may be identified based on the at least one moment and a sentiment of the live event. For instance, if the moment in the live cricket match is about a certain player scoring in a match, then the selected image may include that player's name as a subject along with him/her in the outfit relevant for that match and in a celebratory demeanor. Furthermore, the generated text and the generated image may be combined to generate the at least one real-time update.

The display unit [104] is configured to display the at least one real time update. In one example, the display unit [104] may be a content management system (CMS). For instance, a television application, a mobile application, a desktop application, and the like. The displaying includes but may not be limited to sending an email, sending a message or notification to a user. The at least one real time update is displayed in real time.

The processing unit [102] may further store the real time update in the storage unit [106]. In an implementation of the present disclosure, the processing unit [102] is configured to store one or more real time updates as the live event progresses. In one example, the one or more real time updates may be stored with a time stamp. Further, the processing unit [102] is further configured to detect a progress of the at least one live event for a predetermined time period. The progress of the at least one live event refers to continuation of the live event for a certain period of time. For instance, the at least one live event began at 4:00 p.m. The predetermined time period is 10 minutes, and till 4:10 p.m., three real time updates have been stored in the storage unit [106].

Further, the processing unit [102] is configured to select one or more generated real-time updates from a list of the generated real time updates. The processing unit [102] is configured to select one or more generated real time updates from the generated real time updates stored in the storage unit [106]. In one example, the processing unit [102] may select each of the generated real time updates. In another example, the processing unit [102] may select one or more of the generated real time updates based on a comparison of the importance score. In an implementation of the present disclosure, the generated real time updates with high importance score may be selected by the processing unit [102].

The processing unit [102] is further configured to dynamically merge one or more real-time updates to form a timeline. The timeline, as used herein, refers to a collection of elapsed real time updates of the live event. The timeline may help the users to catch up with what important event has elapsed in the live event in a small amount of time through a collection of visuals. The timeline updates as the live event progresses and keeps on adding more real-time updates as they get generated in real time. Thereafter, the processing unit [102] is configured to display the timeline to the user on the display unit [104].

In one example, a flood alert is issued in city X, but some people have to go to work, some are working from home, some have to travel for some urgent work to other parts of the city. Since many people are busy with work and can't watch live news update all the time, the system [100] may fetch the content stream from live news event and identify the relevant events. The relevant events include but may not be limited to water entering houses in specific areas of city, speed at which water is entering the city, calamities, road blocked by police, and the like. The system [100] may identify and exclude the irrelevant events like advertisements, interviews of people, and the like. The system [100] may generate the text summary for the relevant events and based on the text summary, may generate or extract an image from the storage unit [106]. The text summary may be combined with the image to form the at least one real time update for the moment of water entering into houses with the text summary ‘Water reaches houses and shops of area UVW in city X’ which will be displayed to the user whenever they open their computing device. In furtherance of generation of the real time updates, once the one or more updates are generated, the one or more updates will be stored in the storage unit [106]. The system [100] may select at least one update from the one or more updates to generate the timeline. The timeline indicates the chronology of events taking place during the flood calamity. For instance, the timeline includes water breaching danger mark, villagers near river rescued, water flooding roads, water flooding homes, etc. The timelines and the moments ease user experience and reduce the amount of time required by the user on the news application to stay updated.

Referring now to FIG. 2 that illustrates an exemplary method [200] for automatically generating one or more real time updates for at least one live event. In an implementation, the method is performed by the system [100] as depicted in FIG. 1. The method begins at step [202] and proceeds to step [204] where the method comprises fetching a content stream of the at least one live event by the processing unit [102]. The content stream may be associated with the at least one live event. In an implementation of the present disclosure, the content stream is fetched from one or more external utilities. The content stream refers to a real-time information of the live event continuously. The one or more external utilities may be one of a live streaming utility, a news event, and the like. In an exemplary implementation of the present systems and methods described herein, beginning of the at least one live event or a live event already in progress may be detected by the processing unit [102] to start fetching the content stream. In one example, the content stream of the live event is received through application programming interfaces (APIs)/Feeds/Streams present on the system [100] provided by the one or more external utilities. In an exemplary embodiment of the systems and methods described herein, where the live event relates to a cricket game, the one or more external utilities may include an API that may include the detailed live score or a commentary feed.

Further, at step [206], the method comprises identifying at least one moment from the content stream by the processing unit [102]. The method further comprises analyzing the content stream of the at least one live event by the processing unit [102]. In an implementation of the present solution, a natural language processing model may be used to analyse the content stream. The natural language processing model may convert natural language in the content stream to a machine readable language. In one example, the analysis can be done right from start of the live event to completion of the live event in real-time using intelligence models, where the intelligence models analyse based on highlights of previous similar events that have been noteworthy. The previous similar event highlights may be stored into an artificial intelligence (AI) model as training data, based on which the system [100] identifies the relevant event in the live event.

Based on the analysis, the method further comprises categorizing the content stream into one of at least one relevant event and at least one irrelevant event. For instance, the at least one relevant event refers to an important milestone in the content stream. For instance, in the case of the live cricket event, the at least one relevant event of the analysed content stream may include a player completing 50/100 runs, a wicket, a catch out, missed wickets, reviews, winning, losing, and the like. The irrelevant event refers to parts of the content stream not contributing to the generation of real time updates. For instance, in a natural disaster live information, the at least one irrelevant event of the content stream may include advertisements, an interview of a nature specialist, and the like.

After categorizing the content stream into the at least one relevant event and the at least one irrelevant stream, at least one moment may be identified from the at least relevant event. The method further encompasses calculating an importance score of the at least one relevant event. The importance score refers to criticality or importance of the event. In one example, based on the number of words spoken in a predetermined time duration, a high pitch of a speaker in the content, the processing unit [102] may qualify the content stream as the relevant event. The at least one moment may then be identified based on an importance score. For instance, the relevant event with the maximum importance score may be identified as a moment. It is to be noted that as used herein a ‘moment’ refers to a portion of a pre-defined time interval of the live event. For instance, in the said case of live cricket game the moment may include a clip of 10 seconds wherein a sixer is struck by the batsman.

In a further exemplary implementation, the intelligence model may have stored one or more moments from a previous of a live cricket match event. In one example, the one or more moments include but are not limited to 4 s and 6 s scored; personal milestone of a player; a hat trick; missed catch of a key batsman or a century. The intelligence model may use the one or more moments in the previous live cricket match event to identify the one or more moments in the live event. Another instance may include an event like a nation's budget presentation which may have a moment like key regulation change that impacts certain industry.

Next, at step [208], the method comprises generating, by the processing unit [102], at least one real time update for the identified at least one moment. The at least one real time update includes but may not be limited to an image along with a summarized description of the moment. In an implementation of the systems and methods described herein, the natural language processing AI model processes the at least one moment and generates the one or more tags relevant to the moment. As used herein, the ‘one or more tags’ refers to an attribute associated with the at least one moment. For example, in the said case of the live cricket game event, the one or more tags may include a name of a player, an event name, a score, a team name, an opposition team name, a tournament name, and the like. Further, based on the one or more tags, the text summary may be generated. The text summary, as used herein, refers to a short text description of the at least one moment.

Further, the method comprises identifying an image for the at least one relevant event based on the generated text summary and the one or more tags. In one example, the image may be selected from a storage unit [106]. In another example, the image may be generated using an intelligence model. The images may be pre-stored by a system operator in the storage unit [106] or may be stored from previously generated images. In an implementation of the present disclosure, the image may be identified based on the at least one moment and a sentiment of the live event. For instance, if the moment in the live cricket match is about a certain player scoring in a match, then the selected image may include that player's name as a subject along with him/her in the outfit relevant for that match and in a celebratory demeanor. Furthermore, the method comprises combining the generated text and the identified image to generate the at least one real-time update.

Next at step [210], the method comprises displaying the at least one real time update on a display unit [104]. In one example, the display unit [104] may be a content management system (CMS). For instance, a television application, a mobile application, a desktop application, and the like. The displaying includes but may not be limited to sending an email, sending a message or notification to a user. The at least one real time update is thus displayed in real time to a user. The method [200] terminates at step [212].

Furthermore, the present systems and methods described herein encompass that the generated real-time updates are stored in the storage unit [106]. In an implementation of the present systems and methods described herein, the one or more real time updates may be stored with a time stamp. The method further comprises detecting a progress of the at least one live event for a predetermined time period by the processing unit [102]. The progress of the at least one live event refers to continuation of the live event for a certain period of time. For instance, the at least one live event began at 4:00 p.m. The predetermined time period is 10 minutes, and till 4:10 p.m., three real time updates have been stored in the storage unit [106].

The method further comprises selecting, by the processing unit [102], one or more generated real time updates from the generated real time updates stored in the storage unit [106]. In one example, the processing unit [102] may select each of the generated real time updates. In another example, the processing unit [102] may select one or more of the generated real time updates based on a comparison of the importance score. In an implementation of the present disclosure, the generated real time updates with high importance score may be selected by the processing unit [102]. Furthermore, the method comprises combining, by the processing unit [102], the one or more real time updates to form a timeline. The timeline, as used herein, refers to a collection of elapsed real time updates of the live event. The timeline may help the users to catch up with what important event has elapsed in the live event in a small amount of time through a collection of visuals. The timeline updates as the live event progresses and keeps on adding more real-time updates as they get generated in real time. Furthermore, the method comprises displaying, by the processing unit [102], the timeline to the user on the display unit [104].

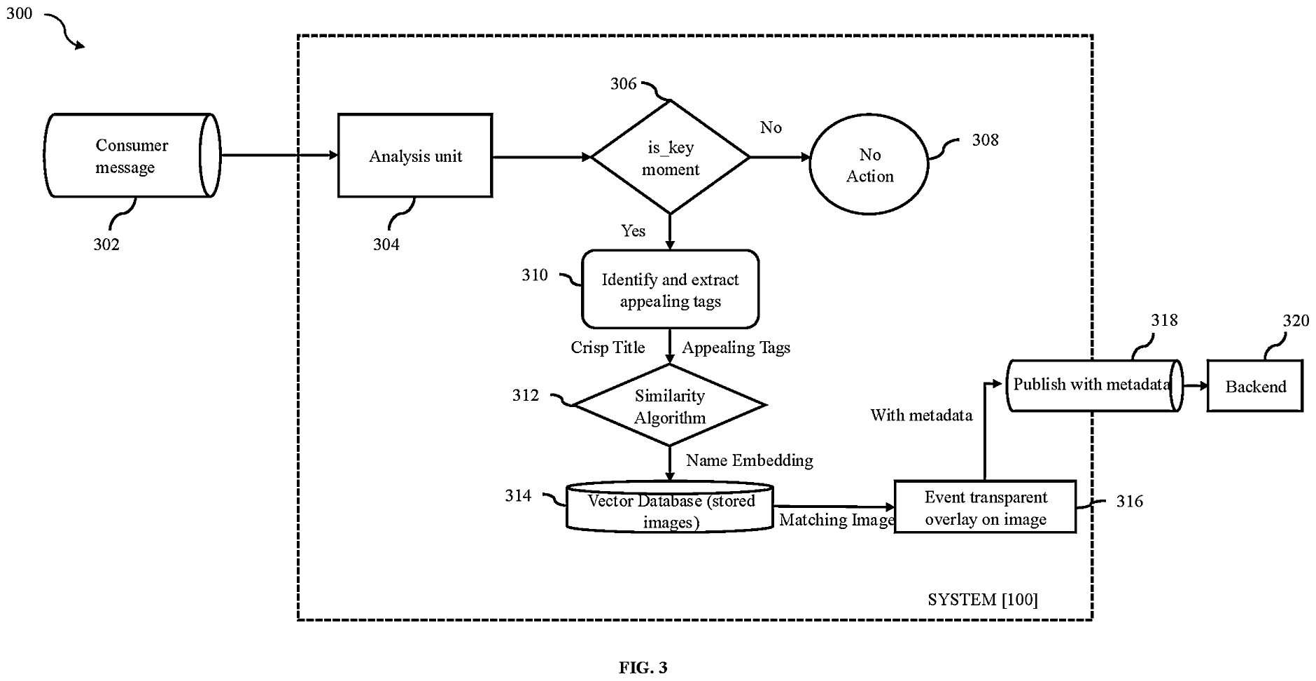

Referring to FIG. 3, an exemplary method [300] for automatic generation of real-time updates for at least one real-time event is shown. In an implementation of the present disclosure, the method [300] is performed by the system [100]. At step [302], the one or more external utilities may send the content stream of the at least one live event to an analysis unit. In one example, the content stream includes but may not be limited to statistics, audio, video, and the like. In an implementation of the present disclosure, the one or more external utilities may be one of an application programming interface (API), a stream, a feed, and the like. In one example, the stream includes a live radio stream. In another example, the feed includes a news data, audio or video feed. At step [304], the content stream of the live event is analysed by the analysis unit. In an implementation of the present solution, the analysis unit may be a natural language processing model or an artificial intelligence model. The analysis unit may convert the natural language in the audio, video in a system readable language.

At step [306], the content stream converted in the machine readable language is further analysed to check if the content stream qualifies as a relevant event or an irrelevant event. In one example, the analysis is based on criticality/importance of the event. In one example, based on the number of words spoken in a predetermined time duration, a high pitch of a speaker in the content, the analysis unit may qualify the content as the important event. In another example, the analysis can be done right from the start of the event to completion of the event in real-time using intelligence derived from highlights of previous similar events that have been noteworthy. The previous similar event highlights may be fed into an artificial intelligence (AI) system as training data, based on which the system [100] identifies such moments in the live event. For instance, in an event of live cricket match event there might be a lot of moments like 4 s and 6 s scored, personal milestone of a player, a hattrick, missed catch of a key batsman or a century which are noteworthy. Another instance may include an event like a nation's budget presentation which may have a moment like key regulation change that impacts certain industry.

If the content stream does not qualify as the relevant event, the method [300] proceeds to step [308]. At step [308], the system [100] may not take any action on that content. If the content qualifies as the relevant event, the method [300] proceeds to step [310]. At step [310], one or more tags may be generated for the selected content. In one implementation, the one or more tags are attributes associated with the selected content. For instance, in the said case of live cricket game, the one or more relevant tags may include name of a player, an event, score, a team, an opposition team, a tournament name, etc. Further, a text generation model may be used to generate one or more relevant text description. The one or more relevant text description may be based on the analysis of the selected content and the one or more tags. In an implementation of the systems and methods described herein, the relevant text description may include textualized summary or a title of the selected content.

Next, at step [312], a similarity algorithm may be applied. The similarity algorithm refers to comparison of the generated text description with one or more previously generated text descriptions to select an image representing the generated text description. At step [314], once the similarity algorithm is applied, the image representing the text description along with a sentiment attached to it, is selected from the storage unit. In an implementation of the present disclosure, the storage unit may contain previously generated real-time images or previously stored images by a system operator. In another implementation of the present disclosure, where the image is not found the repository of images, the image may be created using an image creation model. For instance, if the moment is about player X scoring a 50 in a T20 match for country AB, the image would have the player X as a subject along with the image of the player in the outfit relevant for the T20 match. Further, the player X is shown in a celebratory demeanor with a bat. The image may be selected from the repository of images or created using the image creation model.

Further, at step [316], the image and the text description are combined using a transparent overlay of the text description on the image. The image and the text description in combination is referred to as the real-time update. In an implementation of the present disclosure, the transparent overlay may be one of a portable network graphics (PNG) format. At step [318], the real-time update may be published on the computing device. In an implementation of the present disclosure, the real-time update may be published with a metadata. The metadata refers to additional information relating to the real-time update. The metadata includes but may not be limited to date, a description of the event, the one or more tags of the event, an image format. Furthermore, at step [320], the published real-time update may be stored in a backend of the system [100]. Storing the published real-time update allows for easy retrieval for further generation of real-time updates. Furthermore, the published real-time update may be easily updating in real-time.

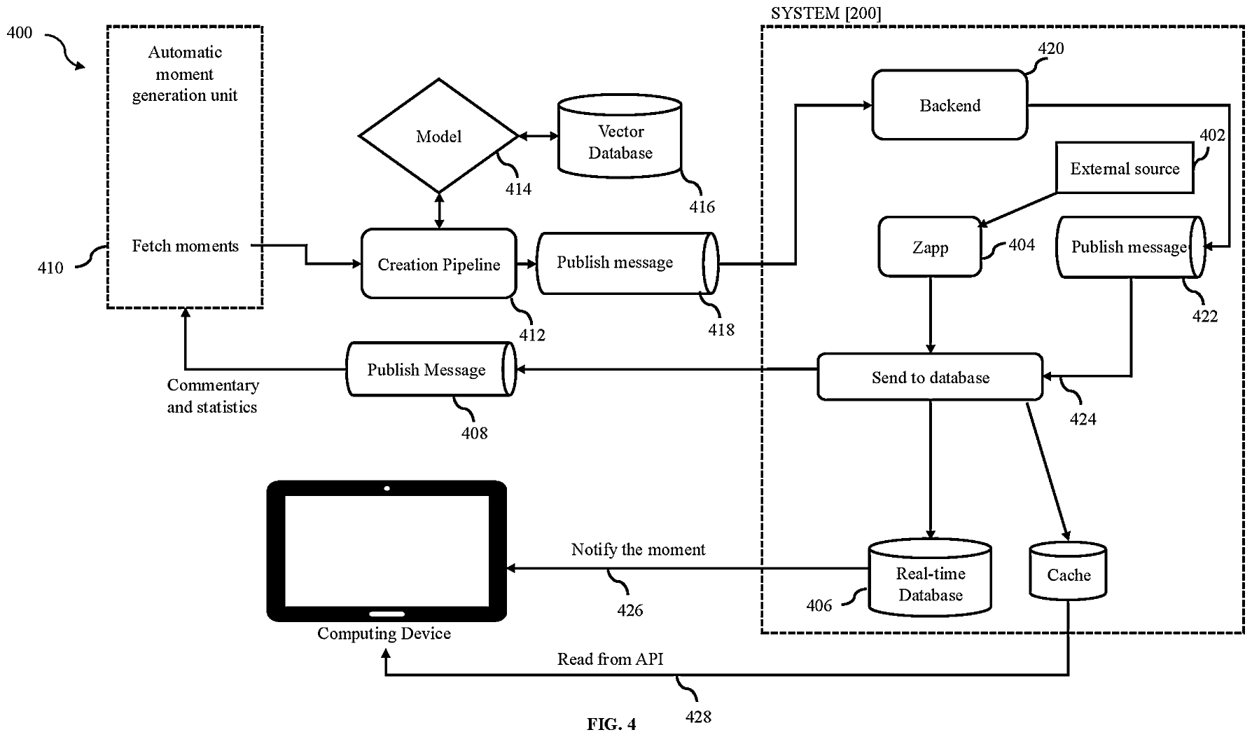

Referring to FIG. 4, an exemplary method [400] for backend publishing of one or more real-time updates for at least one real-time event is shown. In an exemplary embodiment, the backend publishing of one or more real-time updates is for a live cricket match final match. A cricket tournament final is scheduled on a Thursday. Most of the people interested in the match are busy in office, classes, or other events as it is a working day. Not everyone can afford to take a leave, and it is an important and interesting match. With the help of the system [100], installed in their mobile applications, or laptops or desktops, real-time updates of the live cricket match can solve the purpose, as people can continue with their work and check the real-time updates on their computing device in between. Furthermore, if a person is sitting in a meeting, and is not able to check the real-time updates in real-time, the person may go through the timeline of real-time updates to see the highlights of the match in a chronological order later. The exemplary method [400] for fetching the content stream and publishing the real time update is as follows.

The method [400] commences at step [402], where an external utility starts saving the content stream of the live event. In an exemplary aspect of the present disclosure, the external utility may be a radio commentary or a dedicated utility having real time statistics of the live cricket match. At step [404], an analysis unit receives the content stream of the live cricket match from the external utility. The content stream includes but may not be limited to audio of comments of a commentator, statistics of the live cricket match. At step [406], the analysis unit may save the content stream in a real-time database. At step [408], the content stream may be further published by the real time database on a display. Next at step [410], an automatic moment generation unit may fetch a relevant data from the published content stream. An intelligence model may be used to identify the relevant data. The intelligence model may be fed with historical data of similar cricket match events to identify the relevant data. At step [412], the relevant data goes to a creation pipeline. The creation pipeline refers to a unit to generate the text summary and the image relating to the fetched content stream.

At step [414] and [416], the creation pipeline applies the intelligence model to generate the text summary for the fetched content stream. Further, based on the generated text summary, a vector database may be accessed to identify the image relating to the text summary. The image may be stored in the vector database by the system operator or may be generated using the intelligence model. The creation model receives the text summary and the image. The creation model may combine the text summary and the image using a transparent overlay to generate the at least one moment. Further, at step [418], the at least one moment may be published. At step [420], the published moment may be received at a backend and the metadata related to the at least one moment along with the generated moment. At step [422], the metadata related to the at least one moment along with the generated moment may be published. At step [424], the generated moment along with the metadata may be stored in the real time database and a cache. At step [426] and at step [428], the moment may be notified and displayed to the user.

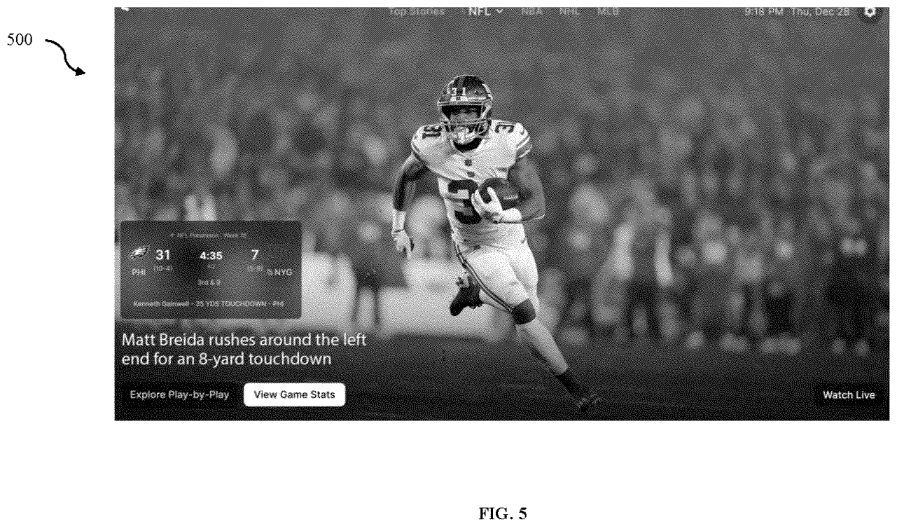

Referring to FIG. 5, an exemplary implementation [500] of an exemplary image with one or more real-time updates for an exemplary event, in accordance with an exemplary embodiment of the present systems and methods described herein. In the context of FIG. 5, an exemplary event, such as a running football match has been considered. As depicted in FIG. 5, a real-time update corresponding to the event, i.e., the running football match is shown. It may be noted that such exemplary event and corresponding real-time updates, as depicted in FIG. 5, are merely exemplary and do not limit the scope of the present subject matter. Any other event, such as a cricket match, a natural disaster, an election counting news, and the like, can be considered and any updates in view of the event may be considered. All such examples would be considered within the scope of the present subject matter.

As shown in FIG. 5, a player named ‘Matt Breida’ runs to the left and covers an eight-yard touchdown to put a score for the team New York Giants (NYG). The event may be termed as the content stream. The processing unit [102] may fetch the content stream and identify the content stream as the at least one moment. Based on the identification, the text summary titled ‘Matt Breida rushes around the left end for an 8-yard touchdown’. The one or more tags may be name of the player ‘Matt Breida’, direction of running, score of team, and the like. Based on the text summary and the one or more tags, an image of the player running with the football may be created or fetched from the storage unit [106]. The text summary and the image are combined and the real-time update as shown in FIG. 5 is displayed on the display unit [104].

The present disclosure further discloses a non-transitory computer readable storage medium storing instructions for automatically generating one or more real-time updates for at least one live event. The instructions include executable code which, when executed by one or more units of a system, cause a processing unit [102] of the system to fetch a content stream associated with the at least one live event. processing unit [102]. The instructions when executed by the system further cause the processing unit [102] of the system to identify at least one moment from the content stream. The instructions when executed by the system further cause the processing unit [102] of the system to generate at least one real time update for the at least one moment. The instructions when executed by the system further cause a display unit [104] to display the at least one real time update.

Therefore, the present systems and methods described herein disclose a method and system for generating real time updates for live events. The present systems and methods described herein provide a significant technical advancement in the field of providing real time updates for time bound events like elections, sports, festivals, live screening of movies, natural disasters, epidemics etc. The present systems and methods described herein provide a moment and a timeline tailored from multiple moments, for updates pertaining to key happenings of the live events in real time. The technical effect of this innovation lies in its seamless integration of multiple components to produce rich visuals and text signifying key happenings both at individual level (i.e., a single moment being generated) as well as collectivised level (multiple moments being generated in a chronological manner via a timeline) to the user. By utilizing natural language processing and generative artificial intelligence techniques, the present systems and methods described herein gives a visual and textual summary of the live event media to the user. The systems and methods described herein provide significant technical advancement and enriches the experience of the content consumers and viewers by updating them in real-time (within instant time interval of not more than 4-5 seconds) with major happenings in live/ongoing events through moments. Further, the technical advancement of timeline feature helps viewers catch up on what has elapsed in a live event in a small amount of time through a collection of visual stories which are a summary of the moments. Furthermore, the timeline feature updates itself as the live event progresses with more moments getting added to the timeline in real time as well as after the completion of the event, thus further enhancing the user experience. The present solution is a fully automated solution of event media visualization thus completely eliminating the need for manual editors to pick and edit moments from live stream videos.

While the present systems and methods described herein have been described with reference to certain preferred embodiments and examples thereof, other embodiments, equivalents and modifications are possible and are also encompassed by the scope of the present disclosure.

We claim:

1. A method for automatically generating one or more real-time updates for at least one live event, the method comprising:
fetching, by a processing unit, a content stream associated with the at least one live event;
identifying, by the processing unit, at least one moment from the content stream;
generating, by the processing unit, at least one real-time update for the at least one moment; and
displaying, by the processing unit, the at least one real time update on a display unit.

2. The method as claimed in claim 1, wherein the content stream is fetched from one or more external utilities comprising at least one of a live streaming event and a news event.

3. The method as claimed in claim 1, wherein identifying the at least one moment from the content stream further comprises:
categorizing, by the processing unit, one or more input data of the content stream into one of at least one relevant event and at least one irrelevant event;
calculating, by the processing unit, an importance score of the at least one relevant event; and
identifying, by the processing unit, the at least one moment from the at least relevant event based on the importance score.

4. The method as claimed in claim 1, wherein generating the at least one real time update further comprises:
determining, by the processing unit, one or more tags for the at least one moment;
generating, by the processing unit, a text summary for the at least one moment;
identifying, by the processing unit, an image for the at least one moment based on the text summary and the one or more tags; and
combining, by the processing unit, the text summary and the identified image to generate the at least one real time update.

5. The method as claimed in claim 1, further comprising:
determining, by the processing unit, a progress of the content stream for the at least one live event;
dynamically merging, by the processing unit, the at least one real time update into a timeline based on the progress; and
displaying, by the processing unit, the timeline on the display unit.

6. A system for automatically generating one or more real-time updates for at least one live event, the system comprising:
a processing unit connected to a storage unit, wherein the processing unit is configured to:
fetch a content stream associated with the at least one live event;
identify at least one moment from the content stream; and
generate at least one real time update for the at least one moment; and
a display unit connected to the processing unit, wherein the display unit is configured to display the at least one real time update.

7. The system as claimed in claim 6, wherein the content stream is fetched from one or more external utilities comprising at least one of a live streaming utility and a news event.

8. The system as claimed in claim 6, wherein the processing unit is further configured to:
categorize one or more input data of the content stream into one of at least one relevant event and at least one irrelevant event;
calculate an importance score of the at least one relevant event; and
identify the at least one moment from the at least one relevant event based on the importance score.

9. The system as claimed in claim 6, wherein the processing unit is further configured to:
determine one or more tags for the at least one moment;
generate a text summary for the at least one moment;
identify an image for the at least one moment based on the text summary and the one or more tags; and
combine the text summary and the identified image to generate the at least one real-time update.

10. The system as claimed in claim 6, wherein the processing unit is further configured to:
determine a progress of the content stream for the at least one live event;
dynamically merge the one or more real-time updates into a timeline based on the progress; and
display the timeline on the display unit.
